(19) United States
(12) Patent Application Publication
(10) Pub. No.: US 2008/0157675 A1
(43) Pub. Date: Jul. 3, 2008

(54) High-Pressure Discharge Lamp

(75) Inventors: Klaus Gunther, Neu Lutterow (DE); Thomas Hartmann, Berlin (DE); Hasnaa Sarroukh, Berlin (DE); George C. Wei, Weston, MA (US)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/884,735

(22) PCT Filed: Feb. 6, 2006
(86) PCT No.: PCT/DE2006/000183

§ 371 Date: Aug. 21, 2007

(30) Foreign Application Priority Data
Feb. 21, 2005 (DE) 10 2005 008 140.1

(51) Int. Cl. H01J 17/20; H01J 61/36; H01J 61/82

(52) U.S. Cl. 313/624; 313/643

(57) ABSTRACT

The invention relates to a high-pressure discharge lamp that has an electric power consumption of less than 50 watt and comprises a discharge vessel (1′) that is sealed on two sides and is made of a translucent ceramic material as well as electrodes (2′, 3′) which are disposed inside the discharge vessel (1′) and are used for generating a gas discharge. Xenon and metal halides are arranged within the discharge vessel (1′) which is embodied as a ceramic tube that has a uniform maximum inner diameter of 1.2 mm while the minimum cold filling pressure of the xenon amounts to 0.8 megapascal.

The invention relates to a high-pressure discharge lamp in accordance with the precharacterizing clause of patent claim 1.

### I. PRIOR ART

Such a high-pressure discharge lamp is disclosed, for example, in EP 1 398 823 A2. This document describes a high-pressure discharge lamp for a motor vehicle headlamp having an electrical power consumption of approximately 35 watts and a tubular discharge vessel, which is sealed off at two ends and consists of a transparent ceramic. In the region of the discharge space and power supply lines, the discharge vessel has different inner diameters.

### II. DESCRIPTION OF THE INVENTION

The object of the invention is to provide a generic high-pressure discharge lamp having an improved discharge vessel.

This object is achieved according to the invention by the features of patent claim 1. Particularly advantageous embodiments of the invention are described in the dependent patent claims.

The high-pressure discharge lamp according to the invention has an electrical power consumption of less than 50 watts and has a discharge vessel, which is sealed off at two ends and comprises a transparent ceramic tube having an inner diameter of less than or equal to 1.2 mm, electrodes and xenon with a coldfilling pressure of at least 0.8 megapascal and metal halides for producing a gas discharge being arranged within the discharge vessel.

The discharge vessel of the high-pressure discharge lamp according to the invention is constructed in such a way that it can be produced in a cost-effective manner using high-productivity powder-ceramic processes. Owing to its uniform low inner diameter, an integral green body can be used for its production which can be produced in a known manner by a high-productivity extrusion process. A further possibility consists in injection molding in a die with the desired outer contour, the uniform inner diameter being ensured by a wire which is withdrawn again once the ceramic compound has solidified. In this case, too, the green body can be produced integrally without any complex joining processes.

Owing to the combination of the comparatively low inner diameter of a maximum of 1.2 mm with a comparatively high xenon coldfilling pressure (i.e. xenon filling pressure at room temperature) of at least 0.8 megapascal, the discharge arc is severely contracted, with the result that the luminance is markedly increased, while the luminous flux remains virtually constant. The severely contracted discharge arc is particularly advantageous for the use of the high-pressure discharge lamp as a light source in an optical system, in particular in a motor vehicle headlamp, which requires sharp imaging of the discharge arc. Preferably, the inner diameter of the discharge vessel in the case of high-pressure discharge lamps which are intended for use in a motor vehicle headlamp has a value in the range of from 0.8 mm to 1.2 mm.

The wall thickness of the discharge vessel is advantageously at least 0.5 mm, at least in the region between the electrodes, i.e. in the region of the discharge arc, in order to make sufficient cooling possible in this region of the discharge vessel, which is particularly severely heated by the discharge arc. In particular, the abovementioned high wall thickness necessitates a correspondingly large outer surface of the discharge vessel in this region and therefore ensures effective radiation cooling. Preferably, the wall thickness of the discharge vessel in the entire discharge space, which extends between the two ends of the electrodes which are connected to the power supply lines, is at least 0.5 mm in order to ensure sufficient heating of the so-called cold spot regions and of the metal halide filling. This measure ensures transport of heat from the center of the discharge vessel, which is hot during lamp operation, to the abovementioned cold spot regions, in which the metal halide filling is present in condensed form.

In order to prevent too much heat being transported to the sealed-off ends of the discharge vessel, the discharge vessel can advantageously have an outer diameter of less than or equal to 2.5 mm outside of the discharge space in the region of its sealed-off ends. That is to say, in this region the discharge vessel has a reduced wall thickness. This reduction in the wall thickness in the region of the electrical leadthrough can be realized by removal of the green body.

That end of the two power supply lines which protrudes into the sealed-off ends of the discharge vessel has in each case one section, which is surrounded by a filament, in order to make it possible to align the power supply lines and the electrodes welded thereto parallel to the longitudinal axis of the discharge vessel. The inner diameter of this leadthrough region is selected according to the invention to be equal to the inner diameter in the discharge region in order that the described high-productivity processes for producing the discharge vessel can be used.

The ionizable filling in the interior of the discharge vessel advantageously comprises halides of the metals sodium and thallium as well as halides of rare earth metals, in addition to xenon, in order to generate white light with a color temperature of approximately 4000 kelvin.

### III. DESCRIPTION OF THE PREFERRED EXEMPLARY EMBODIMENT

The invention will be explained in more detail below with reference to a preferred exemplary embodiment. In the drawings:

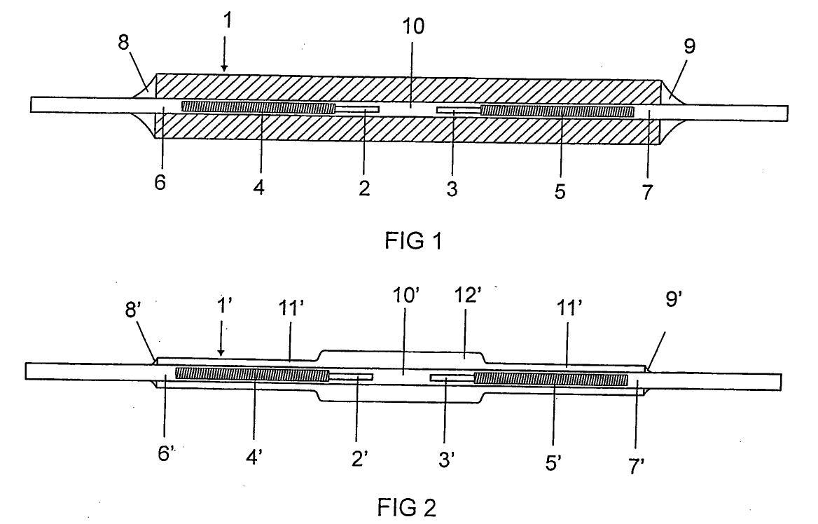

FIG. 1 shows a longitudinal section through a discharge vessel of a high-pressure discharge lamp in accordance with the first exemplary embodiment of the invention,

FIG. 2 shows a longitudinal section through a discharge vessel of a high-pressure discharge lamp in accordance with the second and third exemplary embodiments of the invention, and

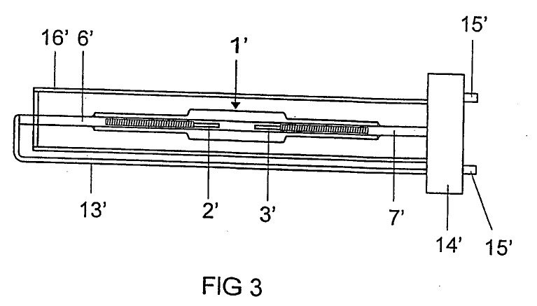

FIG. 3 shows a longitudinal section through the high-pressure discharge lamp in accordance with the second exemplary embodiment of the invention with an outer bulb and a base.

The exemplary embodiments of the invention involve a mercury-free metal halide high-pressure gas discharge lamp with a base at one end for motor vehicle headlamps having an electrical power consumption of approximately 30 watts. The basic design of these lamps is illustrated in FIG. 1 of EP 1 398 823 A1. That is to say the high-pressure discharge lamps in accordance with the exemplary embodiments of the invention each have a discharge vessel 1, which is sealed off at two ends and is surrounded by an outer bulb, a sealed-off end of the discharge vessel and an end of the outer bulb being fixed in a lamp base. The lamp base is equipped with the electrical terminals of the high-pressure discharge lamp. Since the basic design of the high-pressure discharge lamps according to the invention corresponds to the design of the high-pressure discharge lamps described in EP 1 398 823 A1, FIGS. 1 and 2 each only depict the discharge vessel of the high-pressure discharge lamps in accordance with the three exemplary embodiments of the invention.

In accordance with the first exemplary embodiment, the discharge vessel 1 comprises a tube consisting of a transparent, polycrystalline aluminum oxide ceramic. The inner diameter of the tube 1 is uniformly 1.1 mm. The wall thickness of the ceramic tube 1 is 0.9 mm throughout. Two tungsten, rod-shaped electrodes 2, 3 are arranged diametrically at a distance of 4.2 mm in the interior of the tubular discharge vessel 1. They have a thickness or a diameter of 0.3 mm and a length of 3 mm. The electrodes 2, 3 are arranged in the longitudinal axis of the discharge vessel 1. The outwardly pointing end of the electrode 2 or 3 is in each case welded to a 0.3 mm thick molybdenum pin 4 or 5, each of which has two layers of molybdenum wire wound around it. The molybdenum pins 4, 5, around which the molybdenum wire is wound, each have a length of 10 mm and their ends facing away from the respective electrode 2 or 3 are each welded to a 1 mm thick niobium wire 6 or 7, which is led out of the respective end of the discharge vessel 1. The ends of the discharge vessel 1 are sealed off by means of a glass solder 8, 9 in the region of the niobium wires 6, 7. The total length of the discharge vessel is 35 mm. An ionizable filling, which comprises xenon with a coldfilling pressure of 1 megapascal and iodides of the metals sodium, thallium, dysprosium, thulium and holmium, is arranged within the discharge space 10 of the discharge vessel 1. The discharge space 10 extends in the longitudinal direction of the discharge vessel 1 from that end of the electrode 2 which is welded to the molybdenum pin 4 to that end of the electrode 3 which is welded to the molybdenum pin 5. That is to say that, in the present case, it has a longitudinal extent of 10.2 mm. During lamp operation, a discharge arc is formed between the free ends of the electrodes 2, 3, and this is responsible for the light emission. The running voltage of this high-pressure discharge lamp is 60 volts and its maximum luminance is 100 cd/mm². The color temperature of the light emitted by it is 4000 kelvin. The region of the maximum ceramic temperature lies centrally between the electrodes and reaches 1170° C., the cold spot temperature at the location of the molten halides is 900° C., and the temperature of the glass solder in the fuse-in region is 590° C. A lamp life of more than 5000 hours is therefore ensured.

In accordance with the second exemplary embodiment, the discharge vessel 1′ comprises a tube consisting of transparent, polycrystalline aluminum oxide ceramic. The inner diameter of the tube 1′ is uniformly 1.1 mm. Two tungsten rod-shaped electrodes 2′, 3′ are arranged diametrically at a distance of 4.2 mm in the interior of the tubular discharge vessel 1′. They have a thickness or a diameter of 0.3 mm and a length of 3 mm. The electrodes 2′, 3′ are arranged in the longitudinal axis of the discharge vessel 1′. The outwardly pointing end of the electrode 2′ or 3′ is in each case welded to a 0.3 mm thick molybdenum pin 4′ or 5′, each of which has two layers of a molybdenum wire wound around it. The molybdenum pins 4′, 5′, around which the molybdenum wire is wound, each have a length of 10 mm and their ends facing away from the respective electrode 2′ or 3′ are each welded to a 1 mm thick niobium wire 6′ or 7′, which is led out of the respective end. The ends of the discharge vessel 1′ are sealed off by means of a glass solder 8′, 9′ in the region of the niobium wires 6′, 7′. An ionizable filling, which comprises xenon with a coldfilling pressure of 1 megapascal and iodides of the metals sodium, thallium, dysprosium, thulium and holmium, is arranged within the discharge space 10′ of the discharge vessel 1′. The discharge space 10′ extends in the longitudinal direction of the discharge vessel 1′ from that end of the electrode 2′ which is welded to the molybdenum pin 4′ as far as that end of the electrode 3′ which is welded to the molybdenum pin 5′. That is to say that, in the present case, it has a longitudinal extent of 10.2 mm. The wall thickness of the discharge vessel 1′ is 1.2 mm over the entire length of the discharge space 10′ and also 0.9 mm beyond this on both sides. This region 12′ with the thickened wall thickness of 1.2 mm therefore extends over a length of 12 mm. It has an outer diameter of 3.5 mm. In the region 11′ of the sealed-off ends of the discharge vessel 1′, i.e. essentially in the region of the molybdenum pins 4′, 5′ and the niobium wires 6′, 7′, the discharge vessel 1′ has a reduced wall thickness, in comparison with the discharge space 10′, of 0.45 mm, with the result that the outer diameter of the discharge vessel 1′ measures 2 mm in this region. The total length of the discharge vessel is 35 mm. During lamp operation, a discharge arc is formed between the free ends of the electrodes 2′, 3′, and this is responsible for the light emission. The running voltage of this high-pressure discharge lamp is 60 volts and its maximum luminance is 100 cd/mm². The color temperature of the light emitted by it is 4000 kelvin. The maximum temperature of the discharge vessel wall is set in the region between the two electrodes 2′, 3′ and is in this case 1160° Celsius. The temperature in the region of the liquid iodide filling (cold spot region), which is located in the discharge space 10′ close to those ends of the electrodes 2′ and 3′ which are connected to the molybdenum pins 4′ and 5′, respectively, is 980° Celsius. The temperature in the region of the niobium wires 6′, 7′, which are fused in by means of glass solder 8′, 9′, is 550° Celsius. FIG. 3 schematically illustrates the complete high-pressure discharge lamp in accordance with the second exemplary embodiment of the invention. The high-pressure discharge lamp has a lamp base 14′, which is equipped with the electrical terminals 15′ of the lamp. The discharge vessel 1′ is surrounded by a vitreous outer bulb 16′, which consists, for example, of quartz glass or hard glass, which may have additives or dopants absorbing ultraviolet radiation. The niobium wire 6′ which protrudes out of that end of the discharge vessel 1′ which is remote from the base is connected to one of the electrical terminals 15′ via the power return line 13′, which is routed back to the base 14′. The niobium wire 7′ which protrudes out of that end of the discharge vessel 1′ which is close to the base is connected to the other electrical terminal 15′.

The discharge vessels 1 and 1′ in accordance with the two exemplary embodiments explained in more detail above are either produced in a known manner from a deformable compound by extrusion from an endless tube or by press-forming from a heap of powder and then subjected to a sintering process. In order to produce a reduced wall thickness in the region of the sealed-off ends 11′ in the case of the discharge vessel 1′ in accordance with the second exemplary embodiment, the material on the outside of the discharge vessel is removed in this region prior to the sintering process to such an extent that the discharge vessel 1′ has an outer diameter of 2 mm in this region 11′ after the sintering process.

The invention is not restricted to the exemplary embodiments of the invention described in more detail above, but can also be applied to high-pressure discharge lamps with discharge vessels which consist of other transparent, polycrystalline ceramic materials. For example, the discharge vessel may consist of yttrium aluminum garnet or of ytterbium aluminum garnet or of aluminum oxinitride. The dimensions of the discharge vessel and the length of the thickened central part need to be matched to the permissible maximum temperature, the thermal conductivity and the emission capacity of the selected ceramic by means of thermal modeling.

By way of example, a third exemplary embodiment will therefore also be described which consists of aluminum oxinitride for reasons of optical transparency. The discharge vessel has, in principle, the contours illustrated in FIG. 2, the numerical dimensions being matched to the different thermoelectric properties and the different thermal loadability of the material. The inner diameter and the total length of the discharge vessel 1′ are again 1.1 mm and 35 mm. The length of the thickened part 12′ is 12 mm and its outer diameter is 4.5 mm. In the region 11′ of the sealed-off ends of the discharge vessel 1, i.e. essentially in the region of the molybdenum pins 4′, 5′ and the niobium wires 6′, 7′, the discharge vessel 1 has a reduced wall thickness, in comparison with the discharge space 10′, of 0.95 mm, with the result that the outer diameter of the discharge vessel 1′ in this region measures 3 mm. The running voltage of this high-pressure discharge lamp is 60 volts, and its maximum luminance is 100 cd/mm². The color temperature of the light emitted by it is 4000 kelvin. The maximum temperature of the discharge vessel in the region between the electrodes is 1100° C., the temperature in the cold spot region is 945° C. and 580° C. is reached in the fuse-in region at 8′.

1. A high-pressure discharge lamp having an electrical power consumption of less than 50 watts and a discharge vessel (1′), which is sealed off at two ends and consists of a transparent ceramic, as well as electrodes (2′, 3′), which are arranged within the discharge vessel (1′), for producing a gas discharge, xenon and metal halides being arranged within the discharge vessel (1′), characterized in that the discharge vessel (1′) is in the form of a ceramic tube having a uniform inner diameter of less than or equal to 1.2 mm, and the coldfilling pressure of the xenon is at least 0.8 megapascal.

2. The high-pressure discharge lamp as claimed in claim 1, characterized in that the wall thickness of the discharge vessel (1′) is at least 0.5 mm at least in the region between the electrodes (2′, 3′).

3. The high-pressure discharge lamp as claimed in claim 1, characterized in that the wall thickness of the discharge vessel (1′) is at least 0.5 mm at least in the region of the discharge space (10′).

4. The high-pressure discharge lamp as claimed in claim 1, characterized in that the electrodes (2′, 3′) are each connected to a power supply line (4′, 6′; 5′, 7′), which are each passed out of a sealed-off end of the discharge vessel (1′), that end of the power supply lines which protrudes into the discharge vessel (1′) in each case having a section (4′, 5′) which is surrounded by a filament.

5. The high-pressure discharge lamp as claimed in claim 1, characterized in that the outer diameter of the discharge vessel (1′) is less than or equal to 2.5 mm in the region of its sealed-off ends (11′), outside of the discharge space (10′).

6. The high-pressure discharge lamp as claimed in claim 1, characterized in that the metal halides comprise halides of the metals sodium and thallium as well as halides of rare earth metals.

7. The high-pressure discharge lamp as claimed in claim 1, characterized in that the inner diameter has a value in the range of from 0.8 mm to 1.2 mm.

8. The high-pressure discharge lamp as claimed in claim 2, characterized in that the wall thickness of the discharge vessel (1′) is at least 0.5 mm at least in the region of the discharge space (10′).

9. The high-pressure discharge lamp as claimed in claim 2, characterized in that the outer diameter of the discharge vessel (1′) is less than or equal to 2.5 mm in the region of its sealed-off ends (11′), outside of the discharge space (10′).

10. The high-pressure discharge lamp as claimed in claim 3, characterized in that the outer diameter of the discharge vessel (1′) is less than or equal to 2.5 mm in the region of its sealed-off ends (11′), outside of the discharge space (10′).

11. The high-pressure discharge lamp as claimed in claim 4, characterized in that the outer diameter of the discharge vessel (1′) is less than or equal to 2.5 mm in the region of its sealed-off ends (11′), outside of the discharge space (10′).

12. The high-pressure discharge lamp as claimed in claim 8, characterized in that the outer diameter of the discharge vessel (1′) is less than or equal to 2.5 mm in the region of its sealed-off ends (11′), outside of the discharge space (10′).
